(19) United States
(12) Patent Application Publication
(10) Pub. No.: US 2019/0164298 A1
(43) Pub. Date: May 30, 2019

(54) System and Method for Tracking the Speed of an Object Using Video

(71) Applicant: Curv Labs Inc., Toronto (CA)

(72) Inventors: Shea BALISH, Toronto (CA); Jonathan SMITH, Toronto (CA)

(21) Appl. No.: 16/191,288

(22) Filed: Nov. 14, 2018

Related U.S. Application Data
(60) Provisional application No. 62/592,820, filed on Nov. 30, 2017.

(51) Int. Cl. G06T 7/246; G06T 7/194; G06F 3/0484; H04N 5/357

(52) U.S. Cl. CPC G06T 7/246; H04N 5/357; G06F 3/04842; G06T 7/194

(57) ABSTRACT

A system and method are provided for determining ball speed. The method comprises obtaining a video having a plurality of frames; analyzing each frame of the video to detect a position and a size of a ball moving through the frames; calculating the ball speed using the position and size determined from the frames, and a predetermined true size of the ball associated with the video; and outputting the speed of the ball. The analyzing can include applying operations of, background subtraction, noise removal, and motion filtering.

### CROSS-REFERENCE TO RELATED APPLICATIONS

The present application claims priority from U.S. Provisional Application No. 62/592,820 filed on Nov. 30, 2017, incorporated herein by reference.

### TECHNICAL FIELD

The following relates to systems and methods for tracking the speed of an object using video, particularly spherical sports ball.

### DESCRIPTION OF THE RELATED ART

In sports training and competition it is often desirable to measure and track the speed of the ball being used. For example, one may want to determine how fast is a pitch thrown by a baseball pitcher, or how fast was a serve in tennis, a drive in golf, a kick in soccer (football), etc.

There are several existing techniques for measuring ball speed. For example, radar guns have traditionally been used to measure speed using the Doppler effect, but require dedicated equipment (i.e. the radar gun) and someone to operate the equipment. Moreover, radar guns that have a desirable accuracy are known to be expensive and therefore are typically not accessible to recreational players or teams. Lower cost models can be used, but typically do not provide the accuracy that is desired.

Imaging-based techniques have also been attempted, e.g., by tracking speed from a video. However, such techniques have been found to require a complex model of the movement, or environmental data and other inputs in order to achieve a certain level of accuracy.

It is therefore desirable to enable an accurate ball speed measurement without requiring complex and/or expensive equipment or the burden of obtaining extrinsic data that can change depending on where the technique is used.

### SUMMARY

In one aspect, there is provided a method for determining ball speed, comprising obtaining a video having a plurality of frames; analyzing each frame of the video to detect a position and a size of a ball moving through the frames; calculating the ball speed using the position and size determined from the frames, and a predetermined true size of the ball associated with the video; and outputting the speed of the ball.

In other aspects, there are provided a computer readable medium and electronic device for performing the method.

### BRIEF DESCRIPTION OF THE DRAWINGS

Embodiments will now be described with reference to the appended drawings wherein:

FIG. 1 is a schematic diagram of a system for tracking the speed of an object using video;

FIG. 2 is a block diagram of an electronic device configured for tracking the speed of an object using video;

FIG. 3 is a screen shot of an example of a user interface for entering or selecting a size for the ball being tracked;

FIG. 4 is a screen shot of an example of a user interface for selecting a video file or for commencing a live tracking operation;

FIG. 5 is a screen shot of an example of a user interface for selecting a video file;

FIG. 6 is a screen shot of an example of a user interface for controlling a ball tracking routine;

FIG. 7 is a screen shot of an example of a user interface for cropping a video;

FIG. 8 is a screen shot of an example of a user interface for viewing results of a ball tracking routine;

FIG. 9 is a flow chart illustrating computer executable instructions for performing a ball tracking routine; and

FIG. 10 is a flow chart illustrating computer executable instructions for tracking ball movement across frames of a video.

### DETAILED DESCRIPTION

The following provides a system and method for tracking moving objects using video, particularly for tracking the speed and movement of a sports ball, e.g. during a competitive or training event. The method described herein can be applied without requiring extrinsic data about the environment or conditions in which the ball is being used but rather tracks and speed and movement using video and predetermined knowledge of the true size of the ball. In this way, existing and conveniently available equipment such as smart phones and personal computing equipment can be used to obtain and process video in order to determine, output (e.g. display) the results.

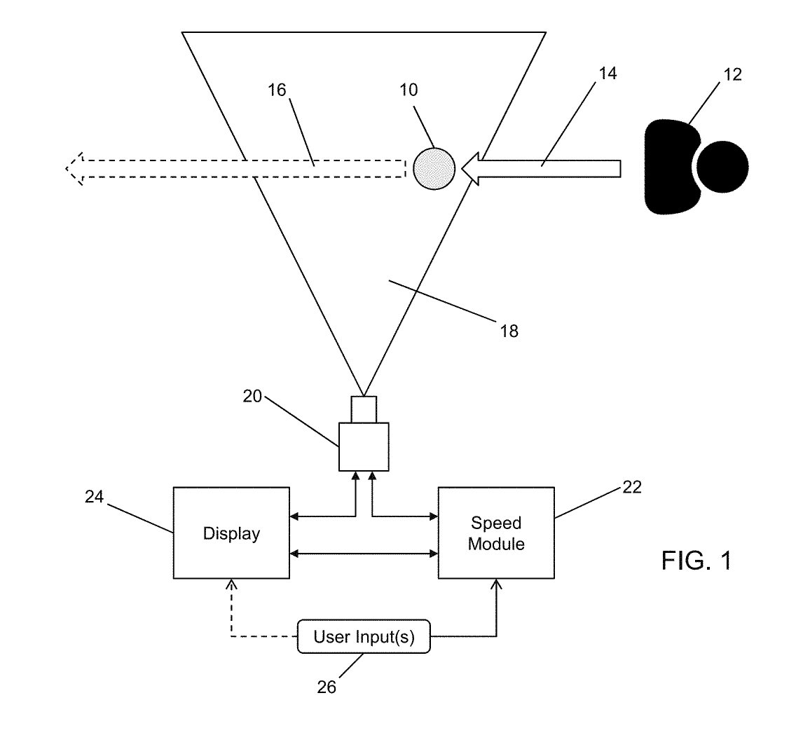

Turning now to the figures, FIG. 1 illustrates an exemplary environment in which a projectile, referred to herein as a sports ball or ball 10 is being thrown or otherwise launched, hit or propelled by a participant 12, or sports equipment operated by such a participant (e.g. racket, bat, etc.—not shown).

The ball 10 has a travelled path 14 and a projected path 16, which is viewable and recordable within a field of view (FOV) 18 of an imaging device 20 such as a camera. Preferably, as shown in FIG. 1, the imaging device 20 is positioned alongside the ball's path (i.e. substantially perpendicular to the path 14) rather than in a position wherein the ball 10 travels at or away from the imaging device 20. This allows the tracking algorithm described herein to detect movement of the ball across the frames of a video.

The imaging device 20 may capture a video of the ball-movement event (e.g., throw, kick, pitch, serve, drive, etc.), and subsequently process that video, or may acquire a live or substantially live video stream that is processed “on-the-fly” in order to track the speed of the ball 10 and report same. Other information that can be detected from the video, such as the angle of movement, etc., can also be determined and reported, e.g., by displaying the data and information to an operator of an electronic device as will be explained below.

The imaging device 20 provides the video data to a speed module 22 for detecting the ball 10 and tracking its speed, and typically also provides the video as an output on a display 24 to enable the video to be viewed by a user. Various user inputs 26 may also be provided to the speed module 22, e.g. via a touch-sensitivity inherent in the display 24 or by some other input mechanism such as a keyboard, button, mouse, etc. It can be appreciated that the manner in which the speed module 22 and interactivity therewith is deployed can vary, and the examples provided herein are for illustrative purposes. For example, in a different implementation, only the imaging device 20 may be located at the sports field or arena, with the video data being sent “offsite” to be processed by the speed module 22 located in a separate computing device or computing service.

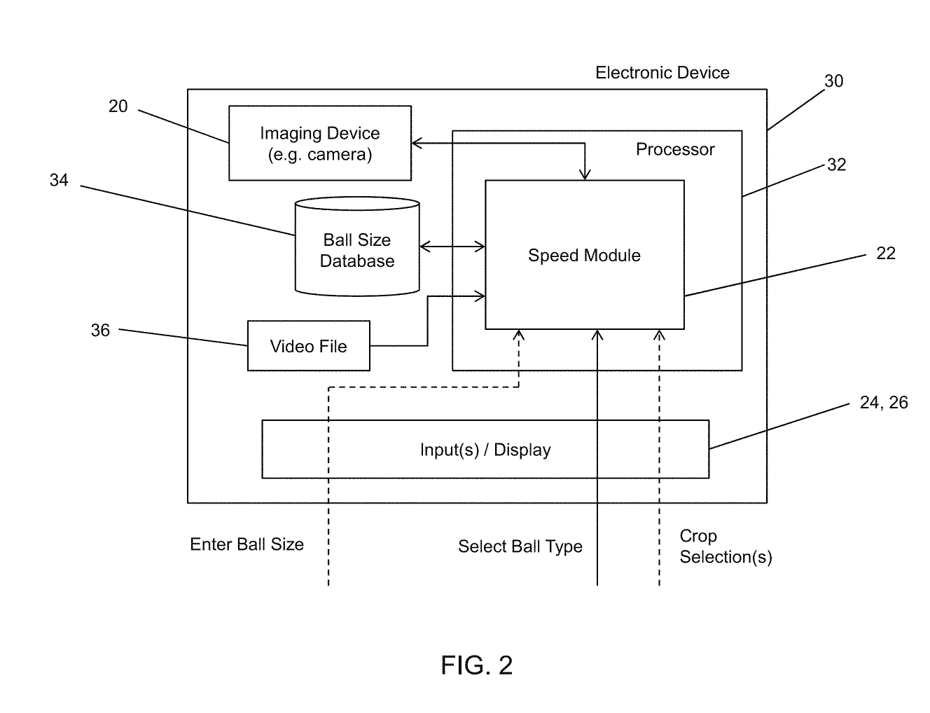

FIG. 2 illustrates one particularly advantageous configuration for utilizing the speed module 22 wherein an electronic device 30 such as a smart phone, smart camera, portable computer (e.g. laptop) or other personal computing device includes the imaging device 20, speed module 22, display 24 and inputs 26 for performing a tracking operation. In this example, the electronic device 30 includes a processor 32 and a database 34 of predetermined or otherwise known or standard actual or “true” ball sizes used by the speed module 22 in tracking the speed of the subject ball 10. For example, the database 34 can store the diameters of known balls 10 such as a hardball, softball, tennis ball, golf ball, soccer ball, etc. The ball size can be selected by the user via one of the inputs 26. Optionally, the speed module 22 can accept entry of a ball size by the user, e.g., for a non-standard size ball (e.g. a training ball). As explained below, another optional input includes a cropping selection for optimizing the tracking process.

The electronic device 30 also stores or otherwise obtains or has access to a video file 36 that is input to the speed module 22 for tracking a ball 10 captured by that video file 36. It can be appreciated that the video file 36 can be stored in memory or provided via incoming streaming data, via a communication connection, or directly from the imaging device 20. For example, the video file 36 can be generated and stored while recording a sporting event, and used by the speed module 22 to perform a speed tracking operation. As such, it can be appreciated that the configuration shown in FIG. 2 is illustrative only. It may be noted that this configuration is particularly suitable for implementing the tracking process using a smart phone or other personal electronic device 30. In this way, accurate speed measurements can be acquired without requiring expensive or additional dedicated electronic equipment.

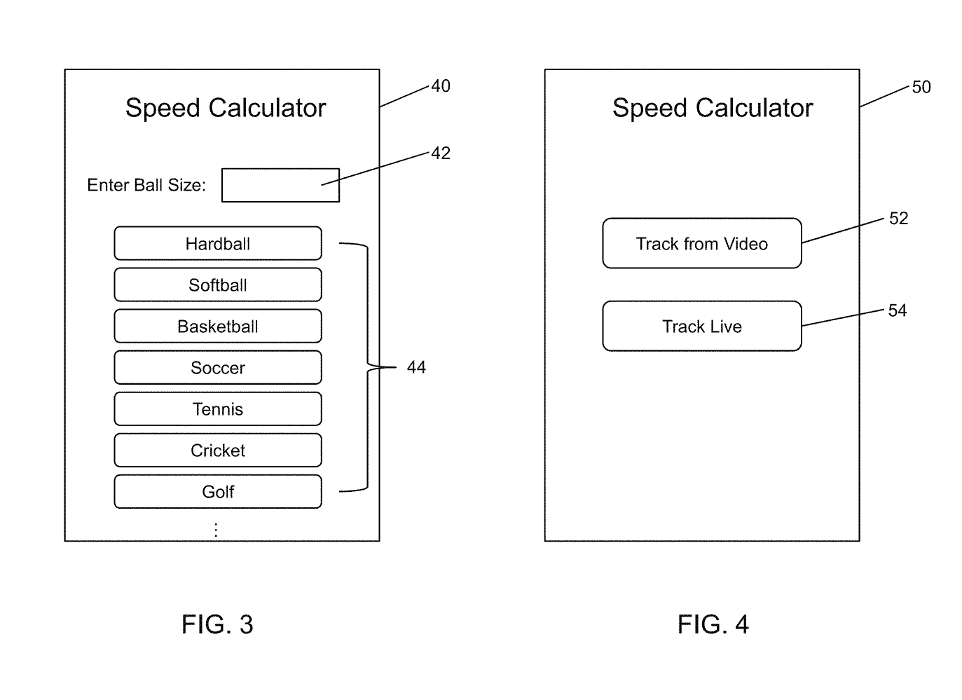

The speed module 22, in addition to performing image processing, can provide or otherwise coordinate with an app having a user interface (UI) displayed using the display 24, and enabling a user to interact with the speed module 22 for performing tracking operations. Screen shots of example UIs are provided in FIGS. 3 to 8.

In FIG. 3, a ball selection UI 40 is shown providing a ball size entry box 42 and a number of predetermined ball type selection options 44. The entry box 42 is an optional feature to enable a user to input the diameter of a ball that is to be tracked, e.g., when there is not a predetermined measurement included with the options 44. The options 44 can be a dynamically changing list, such that additional ball sizes and corresponding options 44 can be added manually by the user, through routine app software updates, etc.

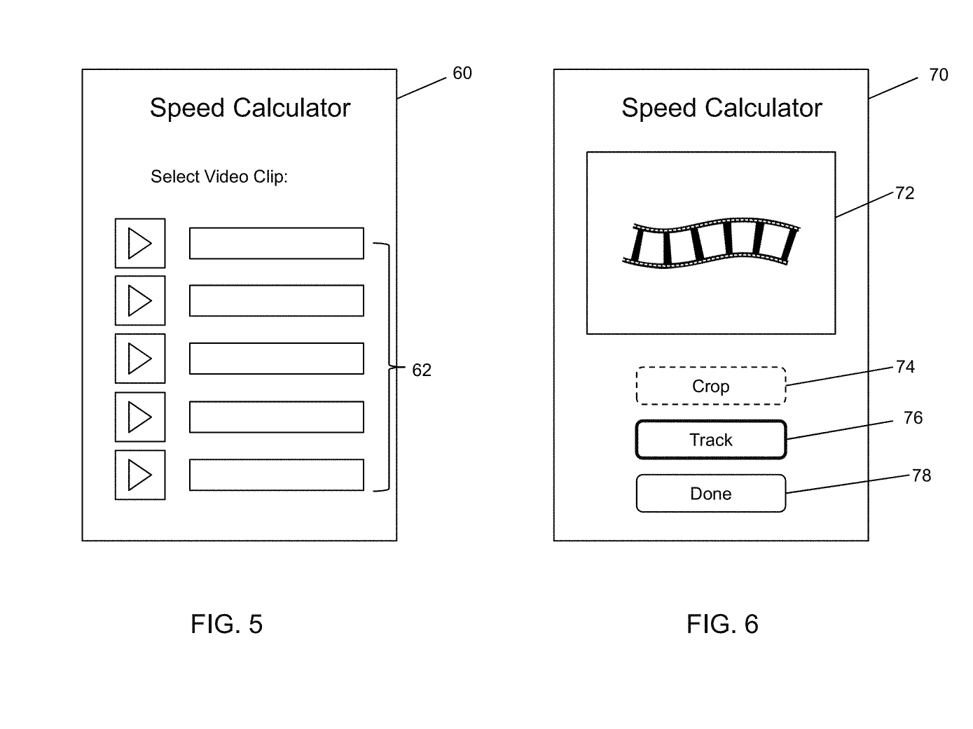

After selecting one of the options 44, or entering a ball size in the entry box 42 in the UI 40, a tracking type UI 50 may be displayed as shown in FIG. 4. The tracking type UI 50 is provided to enable the user to select between tracking the speed of a ball 10 using a pre-recorded video file 36 by selecting a Track from Video option 52, and tracking the speed of a ball 10 from a live video being recorded by the imaging device 20 by selecting a Track Live option 54. When selecting the Track from Video option 52, a video selection UI 60 such as that shown in FIG. 5 can be displayed. The video selection UI 60 in this example provides a list of video clips 62 that the user may select from in order to apply the tracking process.

FIG. 6 provides an example of a video tracking UI 70 that includes a display window 72 for showing/viewing the video clip or live video recording. In this example, the UI 70 includes an optional Crop option 74 for enabling the user to crop the video to select an area that includes only the ball 10 and the path 14 of the ball 10. A Track option 76 and Done option 78 are also provided to enable the process to be started and stopped by the user, e.g., if the video clip includes more than the desired event requiring speed tracking.

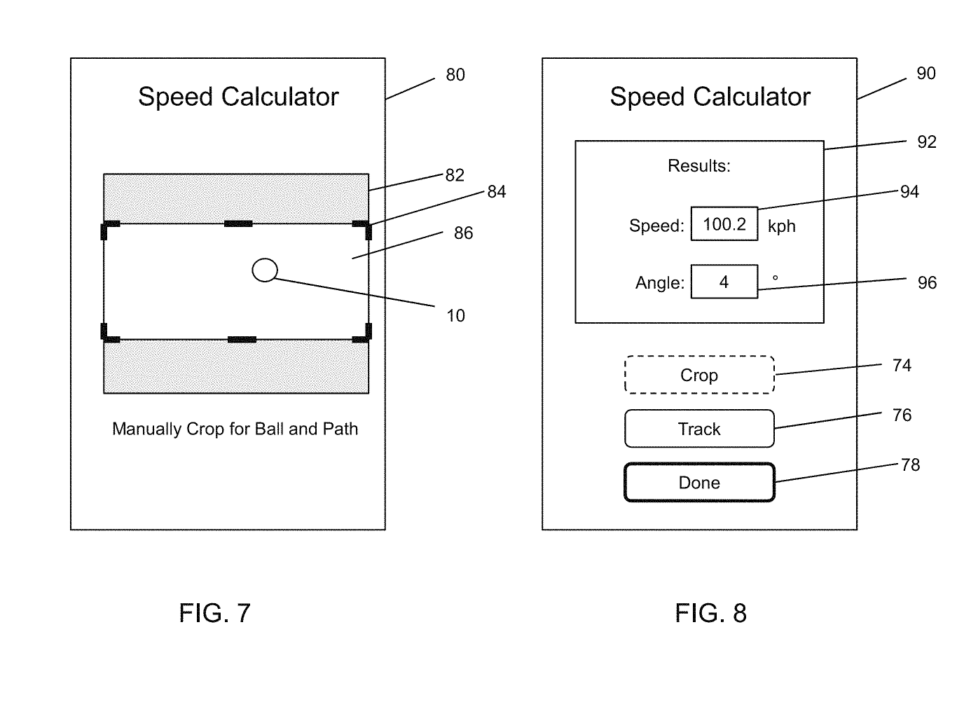

FIG. 7 illustrates an example of a video cropping UI 80 with a display window 82 and crop selection tool 84 that enables the user to size/select the cropped area 86. As explained in greater detail below, the cropping operation is optional, but can be used to optimize the tracking process.

FIG. 8 illustrates a results UI 90 that includes a speed result 84 and an angle result 86 provided in a results window 92. In this example, the results window 92 replaces the video window 72 after the Done option 78 has been selected, and the speed module 22 has executed the tracking process.

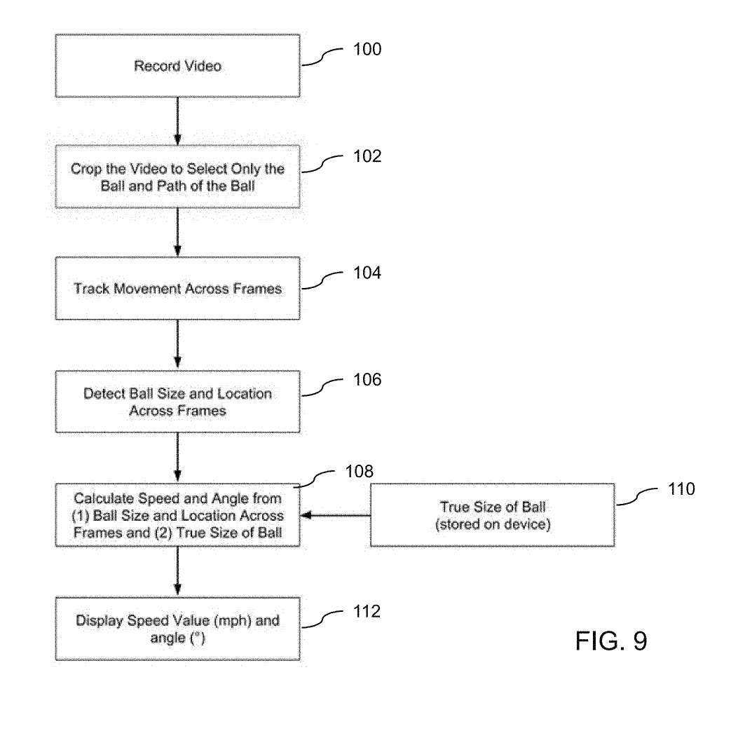

The tracking process employed by the speed module 22 in this example, is shown in FIG. 9.

At step 100, a video is recorded or otherwise obtained. As discussed above, a video file 36 may have been previously recorded, or the video may be captured and processed in real- or substantially real-time. If a “live” video is being processed, it can be appreciated that the tracking process may lag the live video in order to obtain enough frames to detect the ball and calculate the speed. That is, the principles described herein can be adapted to provide ball speed tracking results in various scenarios and environments. For example, during a live video broadcast or recording, incoming video can be analyzed and the ball speed results determined and displayed after a pitch or serve has occurred and the processing has been completed.

At step 102, the video can optionally be cropped to select only or substantially only the ball 10 and path 14, 16 of the ball 10. For example, when analyzing a video file 36, a user can optionally choose to perform a manual cropping operation as illustrated in FIG. 7. The cropping operation can assist in reducing the amount of background information that is to be subtracted during the ball speed tracking process, reducing the processing time required. For example, the movement of the subject in the video can be removed in this way.

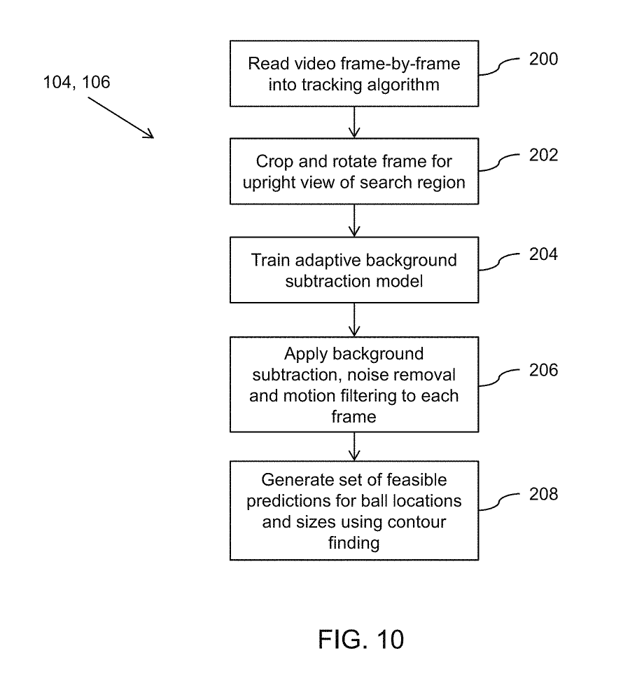

The movement of the ball 10 is then tracked across at least a portion of the frames of the video at step 104. Various operations can be performed at step 104, as exemplified in FIG. 10, described in greater detail below. The movement tracking performed in step 104 then enables the ball size and location across the frames to be detected at step 106. With the ball size and location detected, the speed module 22 then calculates, at step 108, the speed and angle from:

(1) The ball size and location across the frames; and

(2) The true size of the ball 10.

To consider the advantage of knowing the ball size, consider the following example. In this example, if the ball is calculated to be X pixels in diameter, and a real ball is Y millimetres in diameter, then the conversion is now Y/X millimetres per pixel. Next, if one has a distance Z in pixels, then Z*(Y/X) gives us the same distance in millimetres. If a camera has a frame rate of K fps, and the ball travels Z pixels over T frames, then the speed of that ball is estimated at Z*(Y/X)/(T*(1/K)) mm/s.

The true size of the ball 10 is provided as an input at step 110 and is typically stored on the device and provided as an input from predetermined ball sizes or a manually entered ball size as illustrated in the UI 40 in FIG. 3. The speed value and angle value can then be displayed or otherwise output to a user or other system at step 112.

An example sub-routine for performing the tracking operations of steps 104 and 106 is shown in FIG. 10.

At step 200 the video (or portion thereof) is read frame-by-frame into a tracking algorithm executed by the speed module 22. Each frame is then cropped and rotated at step 202, in order to provide an upright view of the search region for the ball 10. This may be done, for example, to detect left/right movement. In some cases, a mobile phone stores a video in a sideways orientation, even if recorded upright, and this step can compensate/correct for that.

The start frame is then determined in order to identify a number of frames prior to this start frame (e.g. 10) for training an adaptive background subtraction model at step 204. Various available models can be used, for example from OpenCV. The background subtraction model is used to determine background features that can be subtracted from the frame when tracking the ball 10 in the frames.

With the background subtraction model trained, and the start frame is reached, each frame is then processed at step 206 to apply: background subtraction to remove unwanted background detail, noise removal, and motion filtering. It can be appreciated that removal of noise can include removal of noise from small movements in the camera, in the background. Methods such as “Erosion” and “Dilation” can be applied here. The motion filtering can be done by subtracting adjacent frames and applying a blurring filter.

With the background subtraction and noise removal operations applied, the remaining contours in the image are considered at step 208 as feasible detections of the ball 10 in each frame. The predictions are generated using contour finding, wherein the largest contour in the image is considered to be the ball 10.

With the ball locations (path) and sizes determined from the frames using the above process, an estimate for ball speed and angle of movement are calculated, as indicated above, which takes into account the true ball size. The size of the contour and the size of the ball is used to generate a conversion between pixels and distance, as exemplified above. Then, the center of the ball 10 is tracked across pixels and its location over time is used to calculate the speed.

As shown in FIG. 8, the calculated values may then be displayed in a UI 90. It can be appreciated that these values can also or instead be sent to another system, e.g., to a remote broadcaster's computer or a cloud-based system that acquires and manages such information.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the electronic device 30, speed module 22, imaging device 20, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of determining ball speed, the method comprising:
obtaining a video having a plurality of frames;
analyzing each frame of the video to detect a position and a size of a ball moving through the frames;
calculating the ball speed using the position and size determined from the frames, and a predetermined true size of the ball associated with the video; and
outputting the speed of the ball.

2. The method of claim 1, wherein the analyzing comprises applying operations of:
background subtraction;
noise removal; and
motion filtering.

3. The method of claim 2, further comprising applying contour finding to results of the operations to detect the ball, wherein the ball is expected to be the largest contour in each frame.

4. The method of claim 1, wherein the analyzing comprises cropping and rotating each frame to provide an upright view of a search region for the ball.

5. The method of claim 1, further comprising training an adaptive background subtraction model using a plurality of frames that precede a start frame.

6. The method of claim 5, wherein the background subtraction model comprises a small learning rate.

7. The method of claim 1, further comprising enabling a manual cropping operation to be applied to the video prior to analyzing each frame, to select ball and path of ball within the video.

8. The method of claim 1, further comprising providing a user interface for selecting a ball type to determine the true size of the ball.

9. The method of claim 8, wherein the user interface for selecting the ball type comprising a plurality of options each identifying a ball type, and an entry box for alternatively entering a ball diameter.

10. The method of claim 1, further comprising calculating a motion angle for the ball, and outputting the motion angle with the ball speed.

11. The method of claim 1, wherein the ball detected in the frames and the true size of the ball are used to generate a conversion between pixels and distance.

12. The method of claim 11, wherein the center of the ball is tracked across pixels and its location over time to calculate the speed.

13. A non-transitory computer readable medium comprising computer executable instructions for determining ball speed, comprising instructions for:
obtaining a video having a plurality of frames;
analyzing each frame of the video to detect a position and a size of a ball moving through the frames;
calculating the ball speed using the position and size determined from the frames, and a predetermined true size of the ball associated with the video; and
outputting the speed of the ball.

14. The non-transitory computer readable medium of claim 1, wherein the analyzing comprises applying operations of:
background subtraction;
noise removal; and
motion filtering.

15. The non-transitory computer readable medium of claim 14, further comprising instructions for applying contour finding to results of the operations to detect the ball, wherein the ball is expected to be the largest contour in each frame.

16. The non-transitory computer readable medium of claim 13, wherein the analyzing comprises cropping and rotating each frame to provide an upright view of a search region for the ball.

17. The non-transitory computer readable medium of claim 13, further comprising instructions for training an adaptive background subtraction model using a plurality of frames that precede a start frame.

18. The non-transitory computer readable medium of claim 17, wherein the background subtraction model comprises a small learning rate.

19. The non-transitory computer readable medium of claim 13, further comprising instructions for enabling a manual cropping operation to be applied to the video prior to analyzing each frame, to select ball and path of ball within the video.

20. An electronic device configured for determining ball speed, the device comprising a processor and memory, the memory storing computer executable instructions for:
obtaining a video having a plurality of frames;
analyzing each frame of the video to detect a position and a size of a ball moving through the frames;
calculating the ball speed using the position and size determined from the frames, and a predetermined true size of the ball associated with the video; and
outputting the speed of the ball.
